(19) United States
(12) Patent Application Publication
(10) Pub. No.: US 2007/0002287 A1
(43) Pub. Date: Jan. 4, 2007

(54) Light-source driving method and projector

(75) Inventors: Morio Matsumoto, Nagano-ken (JP); Shiki Furui, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/569,131

(22) PCT Filed: Jun. 22, 2005
(86) PCT No.: PCT/JP05/12140

§ 371 Date: Feb. 22, 2006

(30) Foreign Application Priority Data
Jun. 24, 2004 (JP) 2004 186354

(51) Int. Cl. G03B 21/20

(52) U.S. Cl. 353/85

(57) ABSTRACT

To provide a light-source driving method for supplying power to a light source of a projector and a projector employing the light-source driving method there are provided a lamp-drive-power control section (3) as a light-source driving section for outputting a first drive waveform and a second drive waveform, and a high-current on-off switch section 5 as a current-control instructing section for making a controllable instruction to switch the first drive waveform and second drive waveform outputted from the lamp-drive-power control section (3).

### TECHNICAL FIELD

The present invention relates to a light-source driving method for supplying power to a light source of a projector, and to a projector using the light-source driving method.

### BACKGROUND ART

The light source of a projector generally employs a discharge-schemed lamp to emit light with intensity. However, where electron discharge is sustained at between the lamp electrodes for a long time, discharge path becomes instable to cause flicker on the projection image. In such a circumstance, there is a light-source driver having a function to stabilize the discharge path and prevent against flicker by carrying out a drive to supply regularly a usual current and a greater amount of current as compared to the usual current, at the end of the light-source driver for supplying power to and putting on (driving) the lamp (see Patent Document 1 (FIG. 4)). There is another consideration to flow a greater amount of current as compared to that in the initial stage of period (see Patent Document 2 (FIG. 3)-(FIG. 6)).

Besides, there is a proposal, as a projection image auto-focus method in a projector, on a method that the test pattern projected onto the screen is imaged by a monitor camera so that a focus position can be sought by detecting a high point of amplitude crest value in a horizontal signal of the photographic image (image data) thus taken (see Patent Document 3).

[Patent Document 1] JP-UM-T-10-501919

[Patent Document 2] JP-T-2002-532867

[Patent Document 3] JP-A-2000-241874

### DISCLOSURE OF THE INVENTION

### Problem that the Invention is to Solve

Here, in the case of carrying out an auto-focus adjustment, in Patent Document 3, by use of the light-source driver prevented against projection-image flicker, in Patent Document 1, the monitor camera senses the increase of light intensity due to a change of the current, within the period of drive waveform, outputted by the light-source driver. As a result, flicker occurs in the image data thus taken, resulting in instable lightness on each of the image data. Accordingly, where using an auto-focus method employing image-data lightness differences, a problem results that correct processing is impossible to carry out.

In order to avoid such instability of lightness, there is considered and practiced a method that a plurality of images are taken in a state the focus lens is placed stationary thereby calculating a mean value. However, it takes a time before reaching a focus alignment. There is a fear that manual focus adjustment is to be achieved rather in a brief time.

Meanwhile, being aware of lightness instability of image data, the increase/decrease of lightness difference may be decided sequentially while moving the focus lens. However, focusing accuracy would be lowered conspicuously. In the case of not carrying out a drive to supply a greater amount of current as compared to the ordinary current regularly within the period of drive waveform in order to avoid the lightness instability of image data, flicker would occur in the projection image as noted above. The resulting image is not easy for the user to view the projection image. For this reason, there is a requisite need to implement a drive to supply a greater amount of current as compared to the ordinary current regularly within the period of drive waveform.

The present invention has been made in view of the foregoing problem, and it is an object thereof to provide a light-source driving method for supplying power to a light source of a projector and a projector employing the light-source driving method.

### MEANS FOR SOLVING THE PROBLEM

In order to achieve the above object, a light-source driving method for a projector to modulate light from a light source by means of a spatial optical modulation element and project an image, the light-source driving method characterized by comprising: providing drive waveforms to the light source different in between auto-focus adjustment and ordinary time.

According to the light-source driving method like this, the light source is driven on different driving waveforms respectively in auto-focus adjustment and in ordinary time.

Consequently, when carrying out an auto-focus adjustment, the image data taken of a projection image, for example, by an imaging device can be provided constant in lightness by driving the light source on the drive waveform for auto-focus adjustment. Meanwhile, in the ordinary time, light source is driven on the drive waveform for usual time thereby enabling to project a projection image free of flicker.

Meanwhile, according to a preferred form of the invention, a light-source driving method is characterized in that the light source is driven on a first drive waveform in the auto-focus adjustment while the light source is driven on a second drive waveform that a current is further added to the first drive waveform in the ordinary time.

According to the light-source driving method like this, when performing an auto-focus adjustment, the light source is driven on the first drive waveform. In the ordinary, the light source is driven on the second drive waveform that a current is added to the first drive waveform.

Consequently, when performing an auto-focus adjustment, the image data taken of a projection image, for example, by means of an imaging device can be provided constant in lightness by driving the light source on the first drive waveform.

Meanwhile, in the ordinary time, the light source is driven on the second drive waveform thereby enabling to project a projection image free of flicker. Meanwhile, in order to achieve the above object, the invention is a projector for modulating light from a light source by means of a spatial optical modulation element and projecting an image, the projector characterized by comprising: drive waveforms to the light source are provided different in between auto-focus adjustment and ordinary time.

According to the projector like this, the light source is driven on different driving waveforms respectively in auto-focus adjustment and in ordinary time.

Consequently, when carrying out an auto-focus adjustment, the image data taken of a projection image, for example, by an imaging device can be provided constant in lightness by driving the light source on the drive waveform for auto-focus adjustment. Meanwhile, in the ordinary time, light source is driven on the drive waveform for usual time thereby enabling to project a projection image free of flicker.

Meanwhile, according to a preferred form of the invention, a projector is characterized in that the light source is driven on a first drive waveform in the auto-focus adjustment while the light source is driven on a second drive waveform that a current is further added to the first drive waveform in the ordinary time.

According to the projector like this, when performing an auto-focus adjustment, the light source is driven on the first drive waveform. In the ordinary, the light source is driven on the second drive waveform that a current is added to the first drive waveform.

Consequently, when performing an auto-focus adjustment, the image data taken of a projection image, for example, by means of an imaging device can be provided constant in lightness by driving the light source on the first drive waveform. Meanwhile, in the ordinary time, light source is driven on the second drive waveform thereby enabling to project a projection image free of flicker.

Meanwhile, according to a preferred form of the invention, a projector is characterized by comprising a light-source driving section for outputting the first drive waveform and the second drive waveform, and a current-control instructing section for making a controllable instruction for switching the first and second drive waveforms outputted from the light-source driving section.

According to the projector like this, the light-source driving section outputs a first drive waveform and second drive waveform for driving the light source. The current-control instructing section makes a controllable instruction for switching the first and second drive waveforms outputted from the light-source driving section.

Consequently, in the case of imaging a projection image by using an imaging device, etc. and making a detection of the image data thus taken to thereby performing an auto-focus adjustment of the projection image on the basis of the detection result, the current-control instructing section is allowed to make a controllable instruction for switching the second drive waveform for ordinary time into a first drive waveform for auto-focus adjustment. Meanwhile, when the auto-focus adjustment completes, it is possible to provide a controllable instruction for switching into a second drive waveform as a drive waveform for the ordinary time. As a result, because the lightness on each of the image data taken can be provided constant in lightness, correct detection and hence correct auto-focus adjustment can be made on the projection image. Meanwhile, in the ordinary time, a projection image free of flicker can be projected.

Meanwhile, according to a preferred form of the invention, a projector is characterized by comprising an image acquiring section for receiving a reflection light of a projection image and acquiring image data, in order to carry out the auto-focus adjustment and an image processing section for making a processing depending upon the image data acquired by the image acquiring section.

According to the projector like this, there are provided an image acquiring section and image processing section in order to perform an auto-focus adjustment. The image acquiring section receives a reflection light of the projection image and acquires it as image data while the image processing section processes the acquired image data.

Consequently, when performing an auto-focus adjustment, the current-control instructing section makes a switching into a first drive waveform and drives the light source. Consequently, when the image acquiring section receives a reflection light of the projection image and acquires it as image data, the lightness of each of the image data acquired can be provided constant in lightness. As a result, the image processing section makes an analytic processing of the image data thereby enabling a correct auto-focus adjustment.

Meanwhile, in order to achieve the above object, the invention is characterized by comprising the light-source driving section, the current-control instructing section and a control section for controlling the current-control instructing section.

According to the light-source driver like this, the light-source driving section outputs first and second drive waveforms for driving the light source while the current-control instructing section makes a controllable instruction for switching the drive waveform in the light-source driving section. The control section controls the current-control instructing section.

Due to this, where the light-source driver is mounted on a projector, when imaging a projection image, for example, by using an imaging device and detecting image data thus taken to thereby performing an auto-focus adjustment of the projection image on the basis of the detection result, the current-control instructing section under control of the controlling section is allowed to make a controllable instruction for switching the drive waveform outputted by the light-source driving section into a first drive waveform for auto-focus adjustment. As a result, because the lightness on each of the image data taken can be provided constant in lightness, correct detection and hence correct auto-focus adjustment can be made on the projection image. Meanwhile, in the ordinary time, the current-control instructing section makes a controllable instruction for switching into a second drive waveform for ordinary time, thus enabling to project a projection image free of flicker.

Further advantageous improvements and embodiments of the invention may be taken from the dependent claims. Hereinafter, the invention will be described with reference to its preferred embodiments and the drawings.

### BRIEF DESCRIPTION OF THE DRAWINGS

FIG. 1 A schematic arrangement diagram for carrying out an auto-focus adjustment of a projector according to a first embodiment of the present invention.

FIG. 2 A chart showing a lamp drive current and a shutter open timing.

FIG. 3 A figure representing a change in time of lightness at a time that flicker occur in image data.

FIG. 4 A flowchart for carrying out an auto-focus adjustment.

FIG. 5 A figure representing a lightness difference in image data on a time axis.

FIG. 6 A schematic arrangement diagram for carrying out an auto-zoom adjustment of a projector according to a second embodiment of the invention.

FIG. 7 A flowchart for carrying out an auto-zoom adjustment.

### BEST MODE FOR CARRYING OUT THE INVENTION

Hereunder, a first embodiment of the present invention will be explained based on the drawings.

### First Embodiment

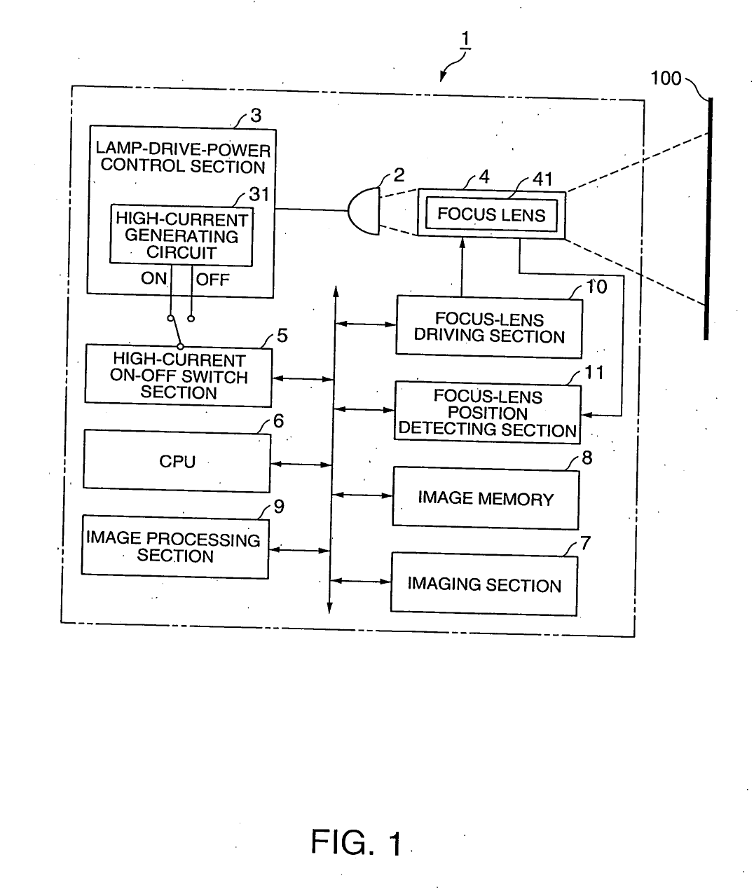

FIG. 1 is a schematic arrangement diagram for carrying out an auto-focus adjustment by use of a lamp drive-power control section as a light-source driving section on a projector.

Using FIG. 1, explanation is made on the construction of a projector 1.

The projector 1 has a lamp 2 as a light source for emitting light, an optical system (not shown) for polarization-converting and color-separating the emission light of the lamp 2 so that those of light are modulated by a spatial light modulation element and combined together, and a projection lens 4 for projecting the combined light through magnification. Thus, an image as combined light is projected onto a screen 100 set up on a wall or the like.

Meanwhile, the projector 1 has a lamp-drive-power control section 3 as a light-source driving section for supplying power to the lamp 2. Also provided is a high-current on-off switch section 5 as a current-control instructing section for controllably instructing, for switching a drive waveform, a high-current generating circuit 31 incorporated in the lamp-drive-power control section 3 and for generating a first drive waveform and a second drive waveform by adding further a current to the first drive waveform. Furthermore, provided is a CPU (Central Processing Unit) 6 as a controlling section for control the operation overall of the projector 1 including those operations.

As a structure for auto-focus adjustment, the projector 1 includes an auto-focus adjusting section having an imaging section 7 as an image acquiring section for imaging a projection image as image data by receiving a reflection light of the image projected on the screen 100, an image memory 8 for storing the image data thus taken, and an image processing section 9 for analyzing the image data. Besides, there are provided a focus lens 41 constituting a projection lens 4 for receiving a signal of analysis result due to the image processing section 9 to focus the projection image, a focus-lens driving section 10 for driving the focus lens 41, and a focus-lens-position detecting section 11 for detecting a position to which to drive the focus lens 41.

In this embodiment, the imaging section 7 employs a CCD (charge coupled device) camera arranged on the projector main body at its projection front surface. Meanwhile, the focus-lens-position detecting section 11 employs an photoelectric rotary encoder to detect a position (moving distance) of the focus lens 41. The focus-lens driving section 10 employs a DC (direct-current) motor to drive the focus lens 41. Those are under control of the CPU 6.

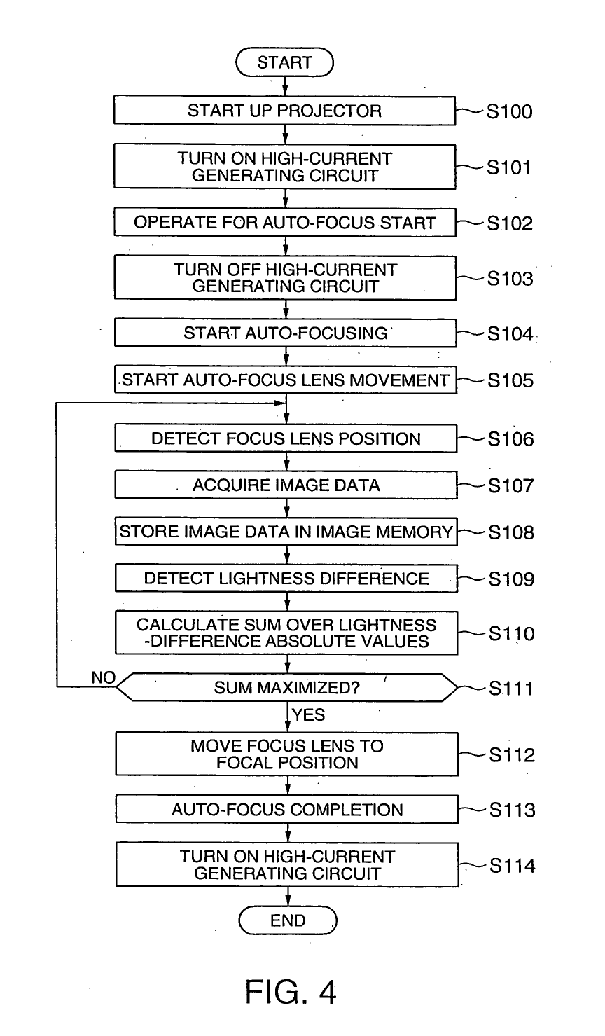

Incidentally, the explanation of auto-focus adjustment based on the FIG. 1 arrangement will be detailed with FIG. 4.

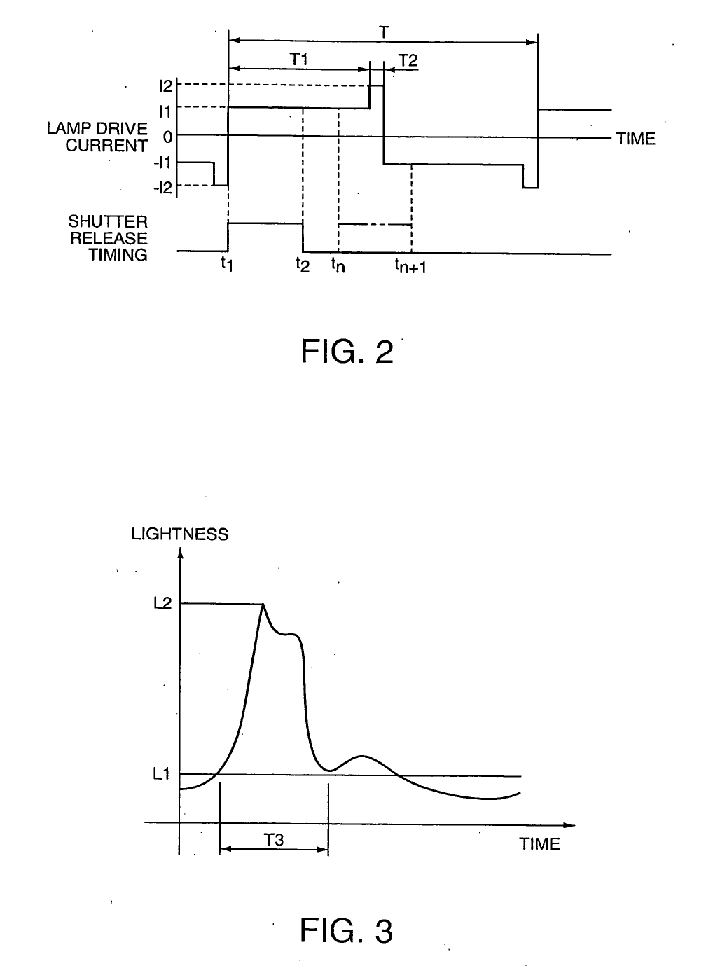

FIG. 2 is a chart showing a lamp-drive-current waveform outputted by the lamp-drive-current control section as well as a shutter release timing by a CCD camera of the imaging section.

Using FIG. 2, explanation is made on a drive current from the lamp-drive-power control section 3 and a shutter release timing by the CCD camera.

As for a current waveform as a lamp drive current outputted by the lamp-drive-power control section 3 in the figure, the axis of abscissa represents a time while the axis of ordinate a drive current. Meanwhile, the current waveform in the figure represents a second drive waveform for driving the lamp 2 in an ordinary time. The drive current is an alternating current whose polarity is inverted (+/−) and repeated with a period T. Specifically, a current I1 as a drive current conforming to the specification of the lamp 2 is outputted for a time T1 while a current I2 (hereinafter, referred to as a high current) greater as compared to the current I1 is outputted for a momentary time T2 immediately before switching of a current from + to −. This output pattern is executed also on the − side, to provide an output repeatedly with a period T of +/−and supply a current to the lamp 2. This embodiment employs a frequency 90 Hz for the period T.

Due to this, the discharge-schemed lamp 2 is applied with an alternating current of drive current I1 from the lamp-drive-power control section 3 whereby electrons are discharged at between the electrodes of an arc tube (not shown) making up the lamp 2, thus causing light emission to give off light. In the lamp 2, electron discharge path is stabilized at between the electrodes by an application of a current I2 higher as compared to the ordinary current I1 for a momentary time T2. This avoids the trouble of flicker on the projection image as caused by an instable discharge path at between the electrodes in the case of electron discharge sustained for a long time.

Here, explanation is made on a trouble encountered upon performing an auto-focus adjustment by use of the lamp-drive-power control section 3 for outputting a second drive waveform to prevent the flicker on the projection image.

By applying the high current I2 to between the electrodes of the lamp 2 periodically for a time T2, discharge path can be stabilized to prevent the flicker on the projection image. This is meant to prevent the flicker for the eye of a human, or the user. However, the CCD camera, when serving as the imaging section 7 in performing an auto-focus adjustment, is to capture, as image data, the projection image due to applying the high current I2, as a means for avoiding such flicker, for a momentary time T2. Thus, a trouble occurrence results that lightness is not stable in the respective ones of image data thus taken (this phenomenon is referred to as image data flicker).

The cause of trouble occurrence is explained by use of a chart as to a shutter open timing shown in FIG. 2.

In the case the imaging section 7 commences an auto-focus adjustment, when the CCD-camera shutter is first opened for a time of up to a time t2 at a timing (time t1) of switching of the lamp drive current from − to + for example, the lamp drive current is given I1 without any change in the lamp drive current. However, in case the CCD camera continuously takes the projection image with a predetermined period, there necessarily encounters a case that shutter open timing is fallen within a time of from tₙ to tₙ₊₁. The lamp drive current, in this case, is given by a drive current portion of the current I1 and high current I2. In this case, the image data taken in the timing of a time of from tₙ to tₙ₊₁ is to be taken extremely higher in lightness than the image data taken first in the timing of a time of from t1 to t2.

In this manner, there occurs a phenomenon (flicker) that lightness differs from image data to image data due to the cause of a difference between the corresponding lamp drive currents depending upon the timing of imaging.

FIG. 3 is a figure showing a lightness change in time at a time that flicker occurs in the image data of a projection image taken by the imaging section. Using FIG. 3, explanation is made on the lightness change of the image data in respect of the image data flicker as noted above.

In FIG. 3, time is shown in a direction of abscissa while image-data lightness is shown in a direction of ordinate. Meanwhile, FIG. 3 shows a lightness change in time (position) where imaging is done in the lamp-drive-current period T shown in FIG. 2 by gradually changing the shutter open timing.

When the shutter open time explained in FIG. 2 lies within a duration (e.g. duration of time from t1 to t2) that a drive current I1 only is applied to the lamp 2, lightness is given L1. On the contrary, in case the shutter open time becomes within a duration including a high current I2 (e.g. duration of time from tₙ to tₙ₊₁), there is appearing a portion where the lightness of image data increases up to L2, as in a time T3 region. This has an effect upon the accuracy in an auto-focus adjustment using lightness difference.

FIG. 4 is a flowchart for performing an auto-focus adjustment in the present embodiment. Using FIGS. 4 and 1, explanation is made on an auto-focus adjusting method in the present embodiment.

At step S100, the user makes an input operation at an input section (not shown) provided on the projector 1, whose operation signal is received by the CPU 6 to start up the projector 1. At step S101, the CPU 6 forwards, to the high-current on-off switch section 5, a signal for issuing an instruction to drive the lamp-drive-power control section 3, in order to cause the lamp 2 to emit light. Receiving the signal, the high-current on-off switch section 5 forwards an “on” signal, or control instruction signal, for outputting a current having a second drive waveform comprising a current I1 and a high current I2, to the high-current generating circuit 31 of the lamp-drive-power control circuit 3. The high-current generating circuit 31 receives the “on” signal and causes the lamp-drive-power control section 3 to start outputting a current having a second drive waveform comprising a current I1 and a high current I2 (similar to the drive waveform shown in FIG. 2). The lamp 2 begins to emit light due to the supply of an output current from the lamp-drive-power control section 3.

At step S102, the user makes an input operation for auto-focus adjustment through the input section provided on the projector 1, whose operation signal is received by the CPU 6 to thereby commence an auto-focus adjustment. Then, the CPU 6 projects a focusing pattern for auto-focus adjustment onto the screen through the projection lens 4.

The focusing pattern, in this embodiment, uses an image configuring a stripe pattern arranging a plurality of black straight lines on a white image plane.

At step S103, the CPU 6 forwards, to the high-current on-off switch section 5, a signal for issuing an instruction to drive the lamp-drive-power control section 3, in order to cause the lamp 2 to emit light for auto-focus adjustment. Receiving the signal, the high-current on-off switch section 5 forwards an “off” signal, or control signal, for outputting a current that the second drive waveform current comprising a current I1 and a high current I2 is switched into a first drive waveform comprising a current I1, to the high-current generating circuit 31 of the lamp-drive-power control section 3. The high-current generating circuit 31 receives the “off” signal and causes the lamp-drive-power control section 3 to output a current that the second drive waveform current comprising a current I1 and a high current I2 is switched into a first drive waveform comprising a current I1. This switches the high current I2 into a current I1, and commences to output the current I1. The period T shown in FIG. 2 is not changed but the high current I2 as a drive current for the time T2 is switched into the current I1 to be outputted. The lamp 2 is switched in its light emission by the supply of the first drive waveform current from the lamp-drive-power control section 3.

Next, the process moves to step S104. At step S104, an auto-focus adjustment is started. The auto-focus adjusting method in the present embodiment is explained with the step S105 and the subsequent steps.

At the step S105, the focus-lens driving section 10 commences to drive the focus lens 41 at from an alignment point of focus where is at a closer distance than the screen 100. At step S106, the focus-lens position detecting section 11 detects a position of the focus lens 41. At step S107, the focusing pattern, or projection image in a position detected, is imaged by the CCD camera, or imaging section 7, to acquire it as image data. At step S108, the focusing-pattern image data thus taken is stored in an image memory 8.

At step S109, the image processing section 9 detects a lightness difference of adjacent pixels, on all the pixels of one of image data, based on the image data stored in the image memory 8. At step S110, the CPU 6 calculates a sum over the absolute values of lightness differences, on the basis of the detected lightness differences. At step S111, the CPU 6 compares the calculation result with the previous one of image data and determines whether or not the sum in this round is smaller than the sum in the last round (whether or not the sum in the last round is the maximum). When not smaller here, the process again moves to the step S106 for execution at from positional detection of the focus lens 41. Then, the steps S106 to S111 are repeated until reaching a decision at the step 111 that the sum over lightness difference absolute values are smaller than the sum in the last time. In this manner, a focus lens position is sought for where the sum over lightness difference absolute values assumes the maximum.

In the case that the CPU at the step S111 decides the sum over lightness difference absolute values in this round is smaller than the sum in the last round (the sum in the last round assumed the maximum), the focus lens position for the image data in the last round is to be decided as a point of focal alignment. At that time, the focus-lens driving section 10 stops the focus lens 41 from moving by means of a signal of the CPU 6. Then the process moves to step S112 where the CPU 6 drives the focus-lens driving section 10 to move the focus lens 41 into the focus-lens position given in the last round where focal alignment is reached. Due to this, the process moves to step S113, thus ending the auto-focus adjustment. Then, the process moves to step S114.

At step s114, the CPU 6 forwards, to the high-current on-off switch section 5, a signal for issuing an instruction to drive the lamp-drive-power control section 3, in order to cause the lamp 2 to ordinarily emit light (light emission for projecting an image the user is to use). Receiving the signal, the high-current on-off switch section 5 forwards an “on” signal, or a control instruction signal, to the high-current generating circuit 31 in order to output the first drive waveform current comprising a current I1 again as a second drive waveform current comprising a current I1 and a high current I2. The high-current generating circuit 31, receiving the “on” signal, causes the lamp-drive-power control section 3 to switch the first drive waveform current comprising a current I1 again into a second drive waveform current comprising a current I1 and a high current I2 and to output it. Due to this, in the lamp-drive-power control section 3, switching is done into a lamp-drive current similar to FIG. 2 to be outputted as a second drive waveform. The lamp 2 is switched into a light emission free of flicker on its projection image, by the supply of the second drive waveform current from the lamp-drive-power control section 3.

Thus, auto-focus adjustment is effected due to the flowchart in the sequence.

Here, during auto-focus adjustment, there is no driving with a high current I2 for preventing flicker on the projection image. Thus, the projection image basically involves flicker. However, in auto-focus adjustment, the time duration is long that the focus lens 41 is out of focal alignment. Thus, the projection image has a low lightness difference in a level that flicker is less perceived visually. Meanwhile, auto-focus adjustment in this embodiment completes in a brief time of within 5 seconds even if including the process against disturbances. Simultaneously with the completion of auto-focus adjustment, the drive current is switched to and outputted as a second drive waveform for outputting a high current I2 according to an instruction of the high-current on-off switch section 5, thus reducing flicker on the projection image to a possible low extent.

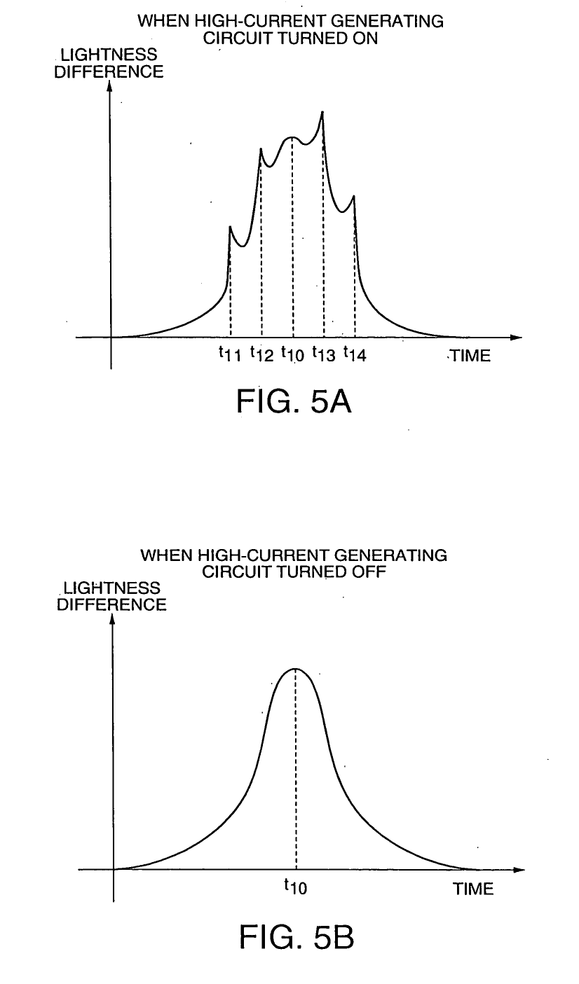

FIG. 5 is a figure representing, in time, a lightness difference in the image data due to imaging the projection image where the focus lens 41 is moved at an equal velocity from a point where focus is aligned at a nearer distance to the screen 100 to a point where focus is aligned at a farther distance thereto. FIG. 5(a) is a figure of a lightness difference in the case the high-current generating circuit 31 is put “on”. FIG. 5(b) is a figure of a lightness difference in the case the high-current generating circuit 31 is put “off”.

Using FIG. 5, explanation is made on the case the high-current generating circuit 31 is put “on” and “off”.

In FIG. 5(a), when the high-current generating circuit 31 goes “on” (in the case of a second drive waveform using a high current I2), there randomly appear light points (time points (area points) represented by t11, t12, t13, t14 in the figure) and ordinarily light points, in the course of moving the focus lens 41. Consequently, the CPU 6 when deciding a maximum value of lightness sum, cannot decide whether or not it is a point in focal alignment on the basis of the detection results of the image processing section 9. At the point t10 in the figure, focus is in alignment.

On the contrary, when the high-current generating circuit 31 goes “off” (in the case of a first drive waveform wherein the high current I2 is decreased down to a current I1) in FIG. 5(b), even in case the focus lens 41 is moved, the lightness of image data is stable and hence the change in lightness difference is also stable. Consequently, concerning the change of lightness difference, as focus comes into alignment, lightness difference gradually increases to reach the maximum at a point t10 in focal alignment. As going out of focal alignment, lightness difference gradually lowers.

In this manner, when implementing an auto-focus adjustment, the high-current generating circuit 31 is switched from “on” to “off” to change the high current I2 down to a current I1 (the second drive waveform is changed to a first drive waveform). This provides a uniform change of lightness difference as shown in FIG. 5(b), enabling an auto-focus adjustment with correctness.

The above first embodiment provides the following effects.

(1) By the provision of the high-current on-off switch section 5, the high current I2 can be changed, for driving, down to a current I1 (the second drive waveform is changed to a first drive waveform) by switching the high-current generating circuit 31 from “on” to “off”. This stabilizes the lightness in the image data taken, making the auto-focus adjustment accurate.

(2) Conventionally, because of comparison of the maximum value of among the sums over lightness difference absolute values, there is a need of a plurality of sheets of image data on each measuring point in a focus lens position. By analyzing the image data and calculating a mean value, the variation of lightness is smoothed to calculate a sum over lightness differences, thus requiring much time in the auto-focus adjustment. However, with the provision of the high-current on-off switch section 5, the high current I2 can be changed down to a current I1 (the second drive waveform is changed to a first drive waveform) by switching the high-current generating circuit 31 from “on” to “off”, to thereby drive the lamp-drive-power control section 3. This enables to capture image data having a stable lightness into the image memory 8. There is satisfactorily required one sheet of image data instead of the need of those in plurality on each measurement point, enabling auto-focus adjustment at high speed. Although the conventional auto-focus adjustment requires a time of about 1 minute from the beginning to end, this embodiment realizes a high-speed processing of 5 seconds or less.

(3) During the auto-focus adjustment, because driving is on the first drive waveform without a drive with a high current I2 for prevention against the flicker on the projection image, flicker is basically involved in the projection image. However, in auto-focus adjustment, because of a long duration the focus lens is out of focal alignment, the projection image has a low lightness difference in a level that the user does not feel flicker. Also, auto-focus adjustment, in this embodiment, completes in a brief time of 5 seconds or less even if including the process against disturbances. Simultaneously with the completion of auto-focus adjustment, the drive current is switched to and outputted as a second drive waveform for outputting a high current I2 according to an instruction of the high-current on-off switch section 5, thus reducing flicker on the projection image to a possible low extent. Thus, auto-focus adjustment is available with substantially no flicker in projection image for the user to feel.

(4) The light-source driver can be configured by a lamp-drive-power control section 3 as a light-source driving section, a high-current on-off switch section 5 as a current-control instructing section, and a CPU 6 as a control section for controlling the high-current on-off switch section 5. By the use of the light-source driver on the projector 1 in this embodiment, the high-current on-off switch section 5 under control of the CPU 6 is allowed to controllably instruct the lamp-drive-power control section 3 to output a drive waveform (output a first drive waveform, in this case), during the auto-focus adjustment. As a result, lightness can be given constant in each image data taken, thus enabling accurate detection of the projection image and hence accurate adjustment.

### Second Embodiment

Explanation is now made on a second embodiment of the invention, based on the drawings.

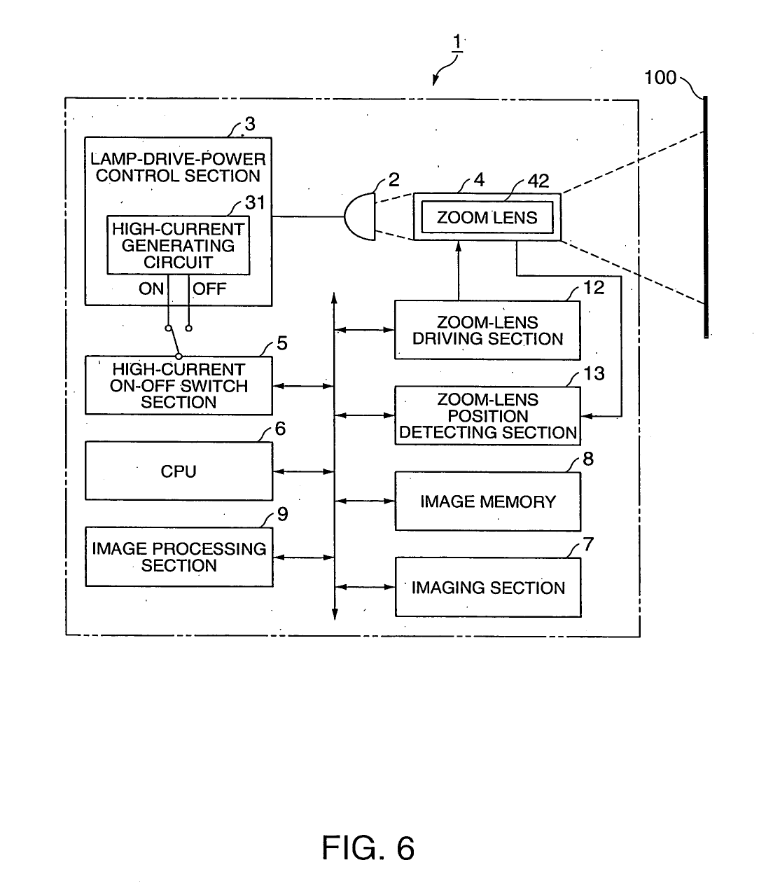

FIG. 6 is a schematic arrangement diagram for performing an auto-zoom adjustment by using a lamp-drive-power control section as a light-source driving section on the projector. Using FIG. 6, explained is the arrangement of the projector 1.

The arrangement of FIG. 6 is explained on the arrangement different from the arrangement of the FIG. 1. The constituent elements like those of FIG. 1 are attached with like references.

The arrangement different from the arrangement of FIG. 1 lies in that the focus lens 41 is replaced with a zoom lens 42, the focus-lens driving section 10 is with a zoom-lens driving section 12, and the focus-lens position detecting section 11 is with a zoom-lens position detecting section 13. The other arrangement is similar to FIG. 1.

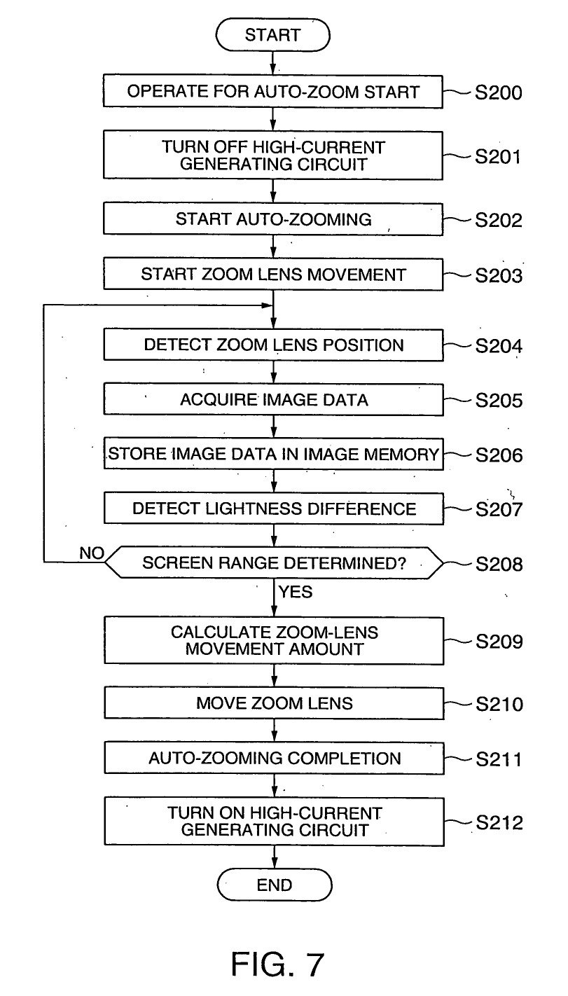

FIG. 7 is a flowchart for performing an auto-zoom adjustment. Meanwhile, the steps S101 and the subsequent in the flowchart shown in FIG. 4 use the flowchart of FIG. 7. Using FIG. 7, explanation is made on the operation.

At step S200, the user makes an input operation for auto-zoom adjustment at the input section provided on the projector 1. The CUP 6 receives the operation signal, to start an auto-zoom adjustment. Then, the CPU 6 projects a zooming pattern for auto-zoom adjustment to the screen 100 through the projection lens 4. In this case, a wholly white image is projected as a zooming pattern.

At step S201, similarly to the step S103 of FIG. 4 the CPU 6 forwards, to the high-current on-off switch section 5, a signal for issuing an instruction to drive the lamp-drive-power control section 3, in order to cause the lamp 2 to emit light for auto-zoom adjustment. Receiving the signal, the high-current on-off switch section 5 forwards an “off” signal, or control signal, for outputting a current that the second drive waveform current comprising a current I1 and a high current I2 is switched into a first drive waveform comprising a current I1, to the high-current generating circuit 31 of the lamp-drive-power control section 3. The high-current generating circuit 31 receives the “off” signal and outputs, from the lamp-drive-power control section 3, a current that the second drive waveform current comprising a current I1 and a high current I2 is switched into a first drive waveform current comprising a current I. This switches the high current I2 into a current I1, to start outputting the current I1. The lamp 2 is switched in light emission by the supply of the first drive waveform current from the lamp-drive-power control section 3.

Next, the process moves to step S202. At the step S202, auto-zoom adjustment is started. The wholly white screen is projected as a zooming pattern to the screen 100. The auto-zoom adjusting method in the present embodiment is explained with the steps S203 and the subsequent.

At the step S203, the zoom-lens driving section 12 commences to drive the zoom lens 42. At step S204, the zoom-lens position detecting section 13 detects a position of the zoom lens 42. At step S205, the zooming pattern, or projection image in a position detected of position, is imaged by the CCD camera, or imaging section 7, to acquire it as image data. At step S206, the image data of zooming pattern imaged is stored in an image memory 8.

At step S207, the image processing section 9 detects a lightness on all the pixels of image data, depending upon the image data stored in the image memory 8. At step S208, the CPU 6 decides a range as to the wholly white by means of a predetermined threshold, depending upon the detected lightness. Then, the screen 100 is determined for its contour within the range of wholly white, by means of the predetermined threshold. Here, in case the contour of the screen 100 cannot be determined, determination is made that the wholly-white screen is assumably in a state placed within the contour of the screen 100. In this case, the process returns to the step S204 where the zoom-lens position detecting section 13 detects, as the next zoom-lens position, a position to which the zoom-lens driving section 12 has driven the zoom lens 42 in order to increase the zoom ratio. At step S205, the zooming pattern enlarged greater than that in the last round is imaged by the CCD camera. In this manner, the sequence of operations is repeated until the contour range of the screen 100 is decided at the step S208.

At step S208, when the CPU 6 decides that the screen 100 at its contour range is placed within the wholly white screen, the process moves to step S209. At the step S209, the CPU 6 reads the contour position of the screen 100 out of the projected as a zooming pattern to the screen 100. The auto-zoom adjusting method in the present embodiment is explained with the steps S203 and the subsequent.

At the step S203, the zoom-lens driving section 12 commences to drive the zoom lens 42. At step S204, the zoom-lens position detecting section 13 detects a position of the zoom lens 42. At step S205, the zooming pattern, or projection image in a position detected of position, is imaged by the CCD camera, or imaging section 7, to acquire it as image data. At step S206, the image data of zooming pattern imaged is stored in an image memory 8.

At step S207, the image processing section 9 detects a lightness on all the pixels of image data, depending upon the image data stored in the image memory 8. At step S208, the CPU 6 decides a range as to the wholly white by means of a predetermined threshold, depending upon the detected lightness. Then, the screen 100 is determined for its contour within the range of wholly white, by means of the predetermined threshold. Here, in case the contour of the screen 100 cannot be determined, determination is made that the wholly-white screen is assumably in a state placed within the contour of the screen 100. In this case, the process returns to the step S204 where the zoom-lens position detecting section 13 detects, as the next zoom-lens position, a position to which the zoom-lens driving section 12 has driven the zoom lens 42 in order to increase the zoom ratio. At step S205, the zooming pattern enlarged greater than that in the last round is imaged by the CCD camera. In this manner, the sequence of operations is repeated until the contour range of the screen 100 is decided at the step S208.

At step S208, when the CPU 6 decides that the screen 100 at its contour range is placed within the wholly white screen, the process moves to step S209. At the step S209, the CPU 6 reads the contour position of the screen 100 out of the lightness-difference detection values, and compares with the contour data of screen 100 read out of the lightness-difference detection values, on the basis of the initial position data of the zoom lens 42. Then, the CPU 6 calculates a movement amount as to by what amount the zoom lens 42 is to be moved from the current position in order to place the wholly white screen within the contour of the screen 100. At step S210, the CPU 6 drives the lens driving section 12 and zoom-lens position detecting section 13 depending upon a current position and moving amount of the zoom lens 42. By moving the zoom lens 42, the wholly white screen is placed within the contour of screen 100. Due to this, the process moves to step S211, thus completing the auto-zoom adjustment.

Incidentally, in the case that the CPU 6 at the step S208 decides that the contour range of screen 100 is placed within the wholly white screen, the process moves to step S209 where the CPU 6 reads the contour position of screen 100 out of the lightness-difference detection values. Then, on the basis of the initial position data of the zoom lens 42, comparison is made with the contour data of screen 100 read out of the lightness-difference detection values. The CPU calculates a moving amount as to by what amount the zoom lens 42 is to be moved from the current position in order to place the wholly white screen within the contour of screen 100. At step S210, the CPU 6 drives the lens driving section 12 and zoom-lens position detecting section 13 depending upon a current position and moving amount of the zoom lens 42. Thus, auto-zoom adjustment is effected by moving the zoom lens 42 to place the wholly white screen within the contour of screen 100.

When the auto-zoom adjustment completes, the process moves to step S212. At the step S212, the CPU 6 forwards, to the high-current on-off switch section 5, a signal for issuing an instruction to drive the lamp-drive-power control section 3 similarly to the step S114 of FIG. 4, in order to cause the lamp 2 to ordinarily emit light (light emission for projecting an image for the user is to use). Receiving the signal, the high-current on-off switch section 5 forwards an “on” signal, or control instruction signal, to the high-current generating circuit 31 in order to output the first drive waveform current comprising a current I1 changed again as a second drive waveform current comprising a current I1 and a high current I2. The high-current generating circuit 31, receiving the “on” signal, causes the lamp-drive-power control section 3 to switch the first drive waveform current comprising a current I1 again into a second drive waveform current comprising a current I1 and a high current I2, to thereby output it. Due to this, in the lamp-drive-power control section 3, switching is done into a lamp-drive current similar to FIG. 2 to be outputted as a second drive waveform. The lamp 2 is switched with a light emission free of flicker on its projection image, due to the supply of the second drive waveform current from the lamp-drive-power control section 3. Thus, auto-zoom adjustment is effected by use of the high-current on-off switch section 5, based on the arrangement and flowchart described above.

The second embodiment provides the following effects.

(1) By the provision of the high-current on-off switch section 5, the high current I2 can be drivably switched down to a current I1 (the second drive waveform is changed to a first drive waveform) by switching the high-current generating circuit 31 from “on” to “off”. Due to this, the taken image data is made in stable lightness, to enable accurate auto-zoom adjustment.

(2) In auto-zoom adjustment, the image data due to imaging the zoom pattern is free of lightness variations. Because the image data to be taken requires satisfactorily one sheet per point, auto-zoom adjustment can be effected at high speed. Consequently, the flicker on the projection image can be reduced to a possible less extent during the process of auto-zoom adjustment. This makes it possible to implement an auto-zoom adjustment with less user's perception of flicker in the projection image.

Incidentally, the present invention is not limited to the above embodiment. Various modifications or improvement can be made to the above embodiment. Modifications are described in the below.

(Modification 1) In the embodiment, the high-current on-off switch section 5 outputs, to the high-current generating circuit 31, an “off” signal, control instruction signal, for outputting a current that the high current I2 is changed to a current I1 (the second drive waveform is changed to a first drive waveform). However, this is not limitative, i.e. the high current I2 may be changed to a previously set current value by the “off” signal, thus being outputted. This can establish a current value to be changed, by looking the level of flicker on the projection image. For example, where flicker are found in the projection image during the process of auto-focus adjustment, a current somewhat higher in value than the current I1 can be outputted without lowering the high current I2 down to the current I1. This can reduce the flicker on the projection image. In this manner, a current value to be switched can be established by confirming the flicker on both the projection image and the image data.

(Modification 2) Because the foregoing embodiment having the high-current on-off switch section 5 can carry out auto-focus and auto-zoom adjustments and hence correction for trapezoidal distortion in the projection image can be made. Specifically, where a trapezoidal distortion occurs, the distance and angle of the projector 1 can be calculated relative to the screen 100 by auto-focus adjustment. By adding thereto a correction based on auto-zoom adjustment, correction is possible to carry out for trapezoidal distortion. In this case, because the image data taken by the imaging section 7 is stabilized in lightness, rapid and correct correction can be effected for trapezoidal distortion.

(Modification 3) The projector 1 having the high-current on-off switch section 5 in the foregoing embodiment is a projector of a transmission liquid-crystal scheme. However, this is not limitative but application is possible to a projector employing a DLP (registered trademark) (Digital Light Processing) scheme and LCOS (Liquid Crystal On Silicon) as a reflective liquid-crystal scheme. Due to this, where auto-focus adjustment, auto-zoon adjustment, etc. are made for a projector employing various schemes, the high-current on-off switch section 5 can switch the drive waveform to the lamp 2, enabling to obtain a projection image and image data free of flicker.

(Modification 4) In the first embodiment, by the provision of the high-current on-off switch section 5, the image data taken can be made stably light free of flicker during the process of auto-focus adjustment. However, this is not limitative. For example, the high-current on-off switch section 5 can be used where implementing a color correcting function that projection is made with colors (red, green, blue, white, black, etc.) onto such a unspecified subject-of-projection plane as a wall so that projection can be made with reverse correction by detecting a difference from the colors in nature relative to the color had by the subject-of-projection plane. Due to this, although conventionally a plurality of sheets of image data are needed because of lightness variations, one sheet merely is satisfactorily required thus improving the speed of executing the color correcting function for the subject-of-projection plane.

(Modification 5) In the first embodiment, the auto-focus adjusting method includes a calculation of the sum over the absolute values of lightness differences in adjacent relationship on all the pixels of the image data. However, this method is not limitative. For example, particular pixels may be established instead of all the pixels of image data so that the sum over absolute values in lightness differences can be calculated only on those pixels. This makes it possible to carry out an auto-focus adjustment at higher speed.

(Modification 6) In the first embodiment, the auto-focus adjusting method uses the method that the sum over the absolute values of lightness differences in adjacent relationship is calculated on all the pixels of the image data so that the position of the focus lens 41 for the image data whose sum is the maximum is taken as a position where focus is in alignment. However, this method is not limitative. For example, the method may be that the position of the focus lens 41, having the greatest lightness which provides the maximum lightness on the image data, is taken as a focus aligned position. Otherwise, the method may be that the position of the focus lens 41, where the lightest point and the darkest point on the image data have the maximum ratio, is taken as a focus aligned position. Otherwise, the method may be that the position of the focus lens 41, where the maximum is the sum over the powers of absolute values of lightness differences between the pixels in an adjacent relationship on the image data, is taken as a focus aligned position.

As explained above, various focus adjusting methods can be employed.

(Modification 7) In the first embodiment, according to the flowchart shown in FIG. 4, auto-focus adjustment, when started at the step S102, is to be started by making an input operation to the projector 1 by the user. However, this is not limitative. After the high-current on-off generating circuit 31 is turned “on” at the step S101, the CPU 6 may be execute a program to issue a signal for causing an operation for commencing an auto-focus adjustment.

(Modification 8) The projection image for use in auto-focus adjustment in the first embodiment uses an image configuring as a focusing pattern, a stripe pattern arranging a plurality of black straight lines over a white image plane. However, this is not limitative but auto-focus adjustment can be effected with a stationary image provided that it is not uniform in color over the image entire surface. This makes it possible to implement an auto-focus adjustment even where using a stationary image for the user to use, thus improving the convenience in the operation for the user to enter a presentation.

### EXPLANATIONS OF REFERENCES

1 . . . Projector, 2 . . . Lamp as a light source, 3 . . . Lamp-drive-power control section as a light-source driving section, 4 . . . Projection lens, 5 . . . High-current on-off switch section as a current-control instructing section, 6 . . . CPU as a control section, 7 . . . Imaging section as an image acquiring section, 8 . . . Image memory, 9 . . . Image processing section, 10 . . . Focus-lens driving section, 11 . . . Focus-lens position detecting section, 12 . . . Zoom-lens driving section, 13 . . . Zoom-lens position detecting section, 31 . . . High-current generating circuit constituting a lamp-drive-power control section, 41 . . . Focus lens, 42 . . . Zoom lens.

1. A light-source driving method for a projector, comprising:
providing drive waveforms to a light source that are different depending on auto-focus adjustment and ordinary time;
modulating light from the light source using a spatial optical modulation element; and
projecting an image.

2. The light-source driving method according to claim 1,
the providing drive waveforms including:
driving the light source on a first drive waveform in the auto-focus adjustment; and
driving the light source on a second drive waveform in the ordinary time, the second drive waveform including a current that is added to the first drive waveform.

3. A projector comprising:
a light source;
a spatial optical modulation element that modulates light from the light source;
a lens to project an image; and
a controller to provide drive waveforms to the light source that are different depending on auto-focus adjustment and ordinary time.

4. The projector according to claim 3,
the light source being driven on a first drive waveform in the auto-focus adjustment, and the light source being driven on a second drive waveform in the ordinary time, the second drive waveform including a current that is added to the first drive waveform.

5. The projector according to claim 3, the controller including:
a light-source driving section to output a first drive waveform and a second drive waveform, and
a current-control instructing section to provide a controllable instruction that switches the first and second drive waveforms outputted from the light-source driving section.

6. The projector according to claim 3, further comprising:
an image acquiring section to receive a reflection light of a projection images, and acquire image data, in order to carry out the auto-focus adjustment; and
an image processing section to provide processing depending upon the image data acquired by the image acquiring section.

7. A light-source driver for a projector that includes a light source, a spacial optical modulation element that modulates light from the light source, and a lens to project an image, the light source driver comprising:
a light-source driving section to output a first drive waveform and a second drive waveform depending on auto-focus adjustment and ordinary time;
a current-control instructing section to provide a controllable instruction that switches the first and second drive waveforms outputted from the light-source driving section; and
a control section to control the current-control instructing section.
